(19) United States
(12) Patent Application Publication
(10) Pub. No.: US 2019/0116511 A1
(43) Pub. Date: Apr. 18, 2019

(54) DATA SENSING METHOD, DATA SENSING MANAGEMENT SYSTEM AND COMPUTER-READABLE STORAGE MEDIA

(71) Applicant: INDUSTRIAL TECHNOLOGY RESEARCH INSTITUTE, Hsinchu (JP)

(72) Inventors: Chun-Hsien WU, Taichung City (TW); Chien-Peng HO, Tainan City (TW); Ping-Lih LIN, Zhunan Township (TW)

(21) Appl. No.: 15/855,760

(22) Filed: Dec. 27, 2017

(30) Foreign Application Priority Data
Oct. 12, 2017 (TW) 106134915

(51) Int. Cl. H04W 24/08; H04B 17/309; G06F 17/30

(52) U.S. Cl. CPC H04W 24/08; H04W 88/02; G06F 17/30943; H04B 17/309

(57) ABSTRACT

An embodiment of a data sensing method includes: dynamically establishing and dynamically updating in a carrier status database at least one carrier status information of at least one carrier that received; based on at least one sensing task requirement and at least the carrier status information of at least one carrier that received, dynamically generating and/or adjusting at least one sensing task; and assigning at least the sensing task to the at least one carrier.

### CROSS-REFERENCE TO RELATED ART

This application claims the benefit of Taiwan application Serial No. 106134915, filed Oct. 12, 2017, the disclosure of which is incorporated by reference herein in its entirety.

### TECHNICAL FIELD

The disclosure relates in general to a data sensing method, a data sensing management system and a computer-readable storage media.

### BACKGROUND

Real-time data sensing may be useful in people daily life. Examples of real-time data sensing are real-time air quality sensing, real-time temperature sensing or real-time mobile signal quality sensing.

As for real-time mobile signal quality sensing, because the mobile communication network is rapidly developed, the mobile devices (for example, smart phones, mobile assistance devices, mobile tablet computers etc.) may be used to collect mobile network sensing data. In real-time mobile signal quality sensing, based on crowdsourcing structure, sensors may be installed on the carriers (for example, the mobile devices) for data sensing and for returning sensing reports to servers.

However, the current real-time mobile signal quality sensing may be suffered by several issues. (1) Sensing quality: the mobile signals are manually sensed and thus it is not easy to follow the standard of the sensing flows. (2) Sensing adaption: although automatic sensing may be performed based on default flows but the sensing operations may be not flexible on demand. (3) Sensing accuracy: if the mobile devices are distributed too centralized or unevenly, the sensing accuracy may be lowered. (4) Real-time data requirement: it is not easily to real-time transmit the sensing results to the server, and in the real-time sensing application service, for example, the mobile communication quality monitoring, the number of the sensing data and real-time transmission of the sensing data may influence the accuracy and satisfaction of the services.

### SUMMARY

The application provides a data sensing method, a data sensing management system and a computer-readable storage media. Embodiments of the application are for mobile sensing application.

According to one embodiment, a data sensing method is provided. The data sensing method includes: dynamically establishing and dynamically maintaining in a carrier status database at least one carrier status information of at least one carrier that received; based on at least one sensing task requirement and the at least one carrier status information of the at least one carrier that received, dynamically generating and/or adjusting at least one sensing task; and assigning the at least one sensing task to the at least one carrier.

According to another embodiment, provided is a data sensing management system communicating with at least one carrier via at least one network. The data sensing management system includes: a carrier status database; a carrier status collection module, being configured for dynamically establishing and dynamically maintaining in the carrier status database at least one carrier status information of the at least one carrier that received; and a sensing task generation and management module, being configured for dynamically generating and/or adjusting at least one sensing task based on at least one sensing task requirement and the at least one carrier status information of the at least one carrier that received, and for assigning the at least one sensing task to the at least one carrier.

According to an alternative embodiment, provided is a computer-readable storage media storing one or more programs, the one or more programs including a plurality of commands. When the one or more programs is read by one or more processors of a data sensing management system, the data sensing management system executes the data sensing method.

### BRIEF DESCRIPTION OF THE DRAWINGS

FIG. 1 shows a functional block diagram for a data sensing system according to an embodiment of the application.

FIG. 2 shows a diagram for carrier status collection according to an embodiment of the application.

FIG. 3 shows a flow chart for carrier status collection according to an embodiment of the application.

FIG. 4 shows a diagram for sensing task generation of a sensing task generation module according to an embodiment of the application.

FIG. 5 shows a flow chart for sensing task generation of a sensing task generation module according to an embodiment of the application.

FIG. 6 shows a diagram for sensing task partition of a sensing task generation module according to an embodiment of the application.

FIG. 7 shows a diagram for sensing task management according to an embodiment of the application.

FIG. 8 shows a diagram for sensing task adjustment according to an embodiment of the application.

FIG. 9 shows a flow chart for sensing task adjustment according to an embodiment of the application.

FIG. 10 shows a diagram for sensing task adjustment according to an embodiment of the application.

FIG. 11 shows a flow chart for sensing task adjustment according to an embodiment of the application.

FIG. 12 shows a diagram for sensing report collection according to an embodiment of the application.

FIG. 13 shows a flow chart for sensing report collection according to an embodiment of the application.

FIG. 14 shows a flow chart for sensing report analysis according to an embodiment of the application.

FIGS. 15A-15D shows an example of communication quality monitoring according to an embodiment of the application.

FIG. 16 shows a flow chart for a data sensing method according to an embodiment of the application.

In the following detailed description, for purposes of explanation, numerous specific details are set forth in order to provide a thorough understanding of the disclosed embodiments. However, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

Embodiments of the application relate to a data sensing method, a data sensing management system and a computer-readable storage media. In embodiments of the application, establishing by monitoring carrier(s) (for example but not limited by, mobile device(s) having sensing function(s), vehicle(s) having sensor(s), or user carrying sensor(s)), the real-time information of the corresponding mobile device(s) (or the carrier(s)) (for example but not limited by, location(s), moving speed, and sensing task information) is sensed. For explanation, the following exemplary embodiments are described in taking the mobile device as an example of the carriers, but the application is not limited by. Other possible embodiments of the application may use other types of carriers, which is still within the spirit and scope of the application.

In embodiments of the application, based on real-time information of one or more mobile devices and the sensing requirement, the sensing task(s) are generated and assigned to the mobile device(s) for execution. Each of the sensing tasks includes sensing parameter(s), sensing frequency and/or sensing algorithm(s).

In embodiments of the application, based on real-time information of one or more mobile devices, a sensing task may be dynamically adjusted (for example, adjusting an assigned task or guiding the mobile device(s) to a sensing location) for adaptive auto-sensing and for improving sensing efficiency and accuracy.

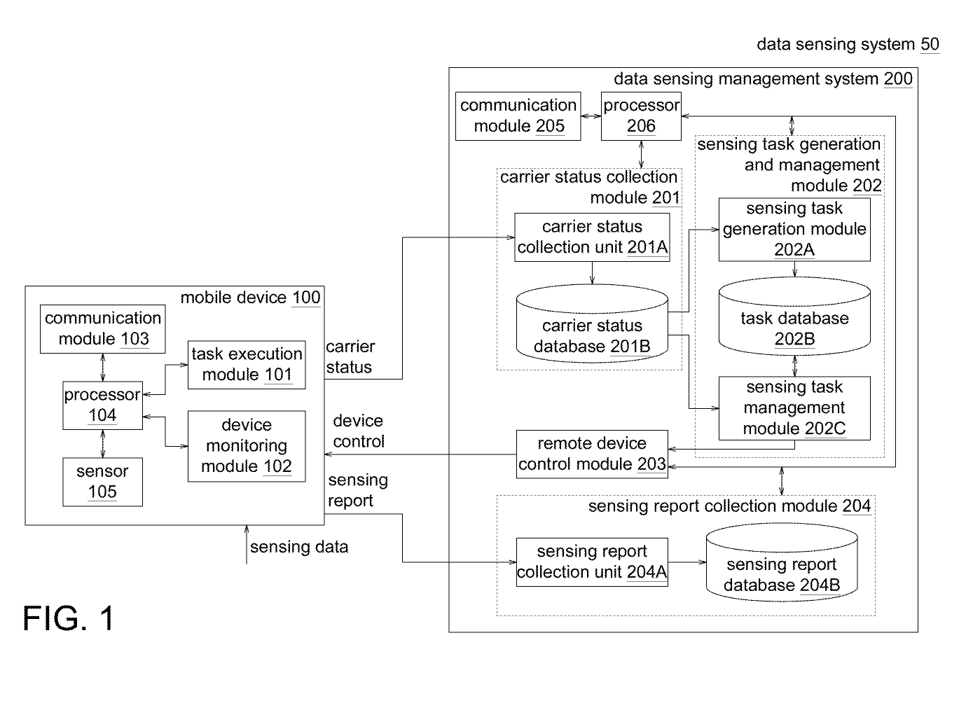

FIG. 1 shows a functional block diagram for a data sensing system according to an embodiment of the application. As shown in FIG. 1, the data sensing system 50 includes: at least one mobile device (carrier) 100 and a data sensing management system 200. The mobile device 100 includes a task execution module 101, a device monitoring module 102, a communication module 103, at least one processor 104 and at least one sensor 105. In an embodiment of the application, the data sensing management system 200 may be a real-time data sensing management system but the application is not limited thereby. The data sensing management system 200 includes a carrier status collection module 201, a sensing task generation and management module 202, a remote device control module 230, a sensing report collection module 204, a communication module 205 and at least one processor 206. The data sensing management system 200 communicates with the mobile device 100 via network (for example wireless network or mobile network). In an embodiment of the application, the task execution module 101 and the device monitoring module 102 of the mobile device 100 may be implemented by software, hardware or firmware. Similarly, the carrier status collection module 201, the sensing task generation and management module 202, the remote device control module 230 and the sensing report collection module 204 of the data sensing management system 200 may be implemented by software, hardware or firmware.

The task execution module 101 may execute the tasks assigned to the mobile device 100 from the data sensing management system 200.

The device monitoring module 102 may monitor the device status (i.e. the carrier status) of the mobile device 100 and send to the data sensing management system 200.

The communication module 103 may communicate with the communication module 205 of the data sensing management system 200 via network.

The processor 104 may control other operations of the mobile device 100 and may control the mobile device 100.

The sensor 105 may perform data sensing.

The carrier status collection module 201 may collect the carrier status from the mobile device 100. The carrier status collection module 201 includes a carrier status collection unit 201A and a carrier status database 201B.

Based on sensing requirement, the sensing task generation and management module 202 may generate, assign and manage the sensing tasks. The sensing task generation and management module 202 includes a sensing task generation module 202A, a task database 202B and a sensing task management module 202C.

The remote device control module 230 may remotely control the mobile device 100 based on the device control command received from the sensing task generation and management module 202.

The sensing report collection module 204 may collect the sensing results feedback from the mobile device 100. The sensing report collection module 204 includes a sensing report collection unit 204A and a sensing report database 204B.

The processor 206 may control other operations of the data sensing management system 200 and may control the data sensing management system 200.

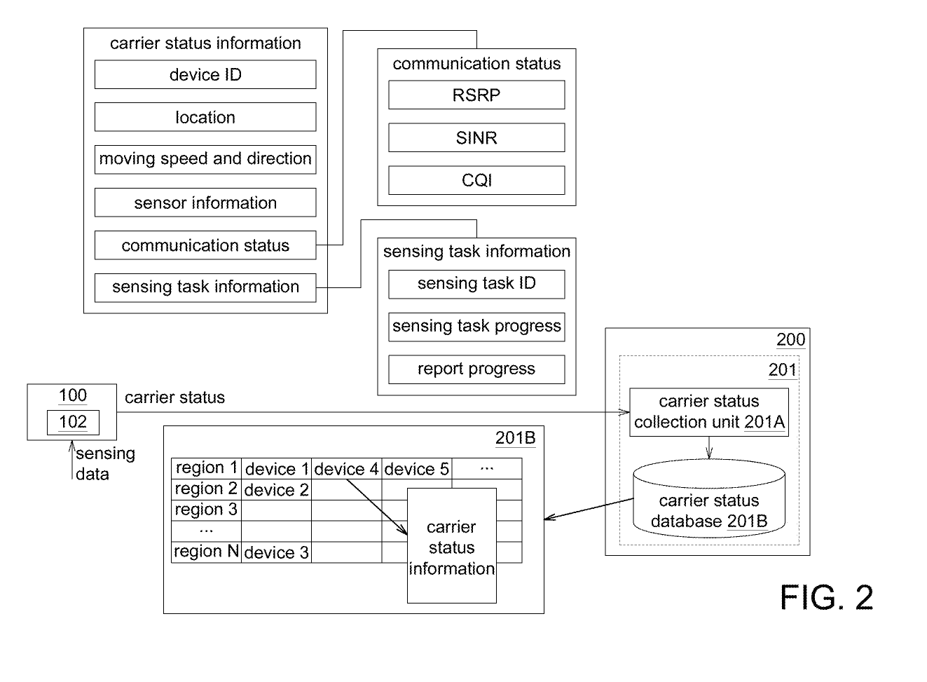

FIG. 2 shows a diagram for carrier status collection according to an embodiment of the application. As shown in FIG. 2, the carrier status of the mobile device 100, which is sent from the device monitoring module 102 to the data sensing management system 200, includes at least one of at least one device information (carrier information) and at least one sensing task information. The device information includes at least one or any combination of the following: a device ID (carrier identification), a location (the current device location), a moving speed (the current device speed), a direction (the current device moving direction), communication status (for example but not limited by, RSRP (Reference Signal Receiving Power), SINR (Signal-to-Interference-plus-Noise Ratio), CQI (Channel Quality Indicator)) and sensor information. The sensor information indicates the types of the sensor(s) on the mobile device. The sensing task information includes at least one or any combination of the following: a sensing task ID, a sensing task progress and a report progress. The sensing task progress indicates the current progress completed by the mobile device 100. The report progress indicates the progress that the mobile device 100 reports sensing data to the data sensing management system 200. For example, the sensing task includes an assignment of processing a hundred of sensing data (number of sensing records is a hundred). If the mobile device 100 completes eighty of the sensing data (number of completed sensing records is eighty), then the sensing task progress is “80 sensing data are completed (80% is completed in this case)”. If the mobile device 100 reports fifty sensing data records to the data sensing management system 200, then the report progress is “50 sensing data are reported (50% is reported in this case)”.

After the carrier status collection unit 201A receives the carrier status from the mobile device 100, the carrier status collection unit 201A stores the carrier status in the carrier status database 201B. As shown in FIG. 2, in the carrier status database 201B, the carrier status may be stored based on the correspondence between the region and the mobile device. For example, the device 1, the device 4 and the device 5 are in the region 1; the device 2 is in the region 2; and the device 3 is in the region N (N being a positive integer).

As for the region, in an embodiment of the application, by algorithm calculation, the longitude and the latitude of a location may be converted into a region. Thus, in the embodiment of the application, by inputting a region number, the coverage of the region is known. For example, Taiwan may be divided into hundreds of regions, each region being numbered and having its own coverage and location.

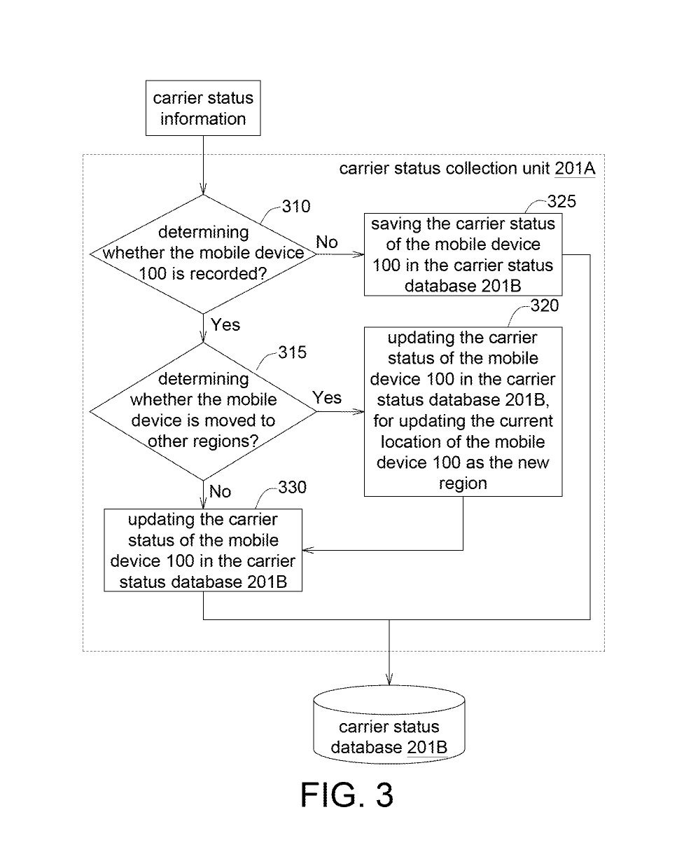

FIG. 3 shows a flow chart for carrier status collection according to an embodiment of the application. After receiving the carrier status of the mobile device 100, in step 310, the carrier status collection unit 201A determines whether the mobile device 100 is a recorded device (i.e. whether the device ID of the mobile device 100 is saved in the carrier status database 201B or not). For example, based on the device ID or MAC address of the mobile device 100, the carrier status collection unit 201A determines whether the mobile device 100 is a recorded device. If no in step 310, the carrier status collection unit 201A saves the carrier status of the mobile device 100 in the carrier status database 201B (step 325). If yes in step 310, the carrier status collection unit 201A determines whether the mobile device is moved to other regions (step 315). If yes in step 315, the carrier status collection unit 201A updates the carrier status of the mobile device 100 in the carrier status database 201B, for updating the current location of the mobile device 100 as the new region (step 320). If no in step 315, the carrier status collection unit 201A updates the carrier status of the mobile device 100 in the carrier status database 201B (step 330).

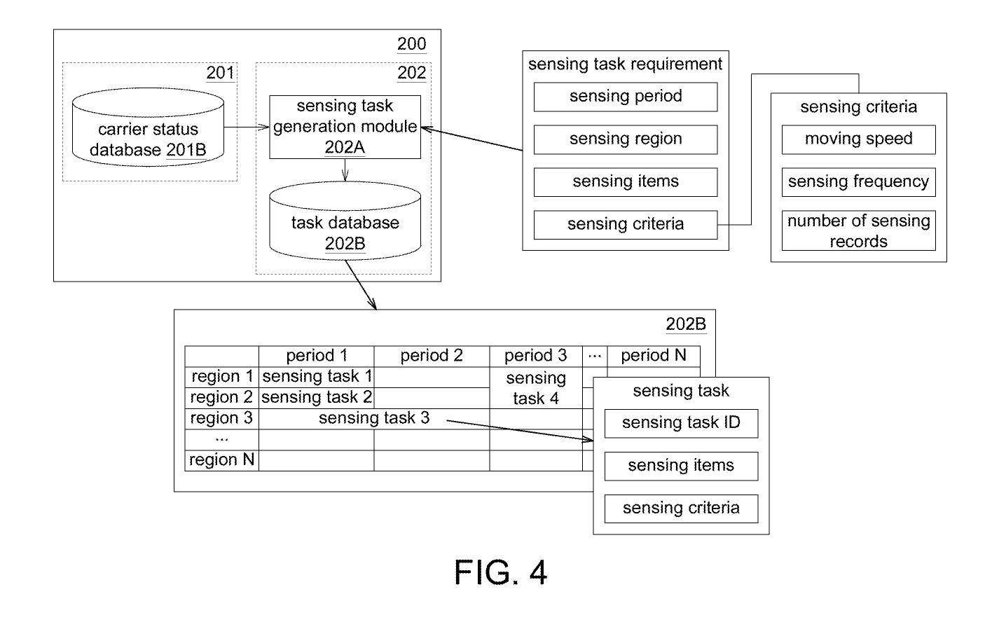

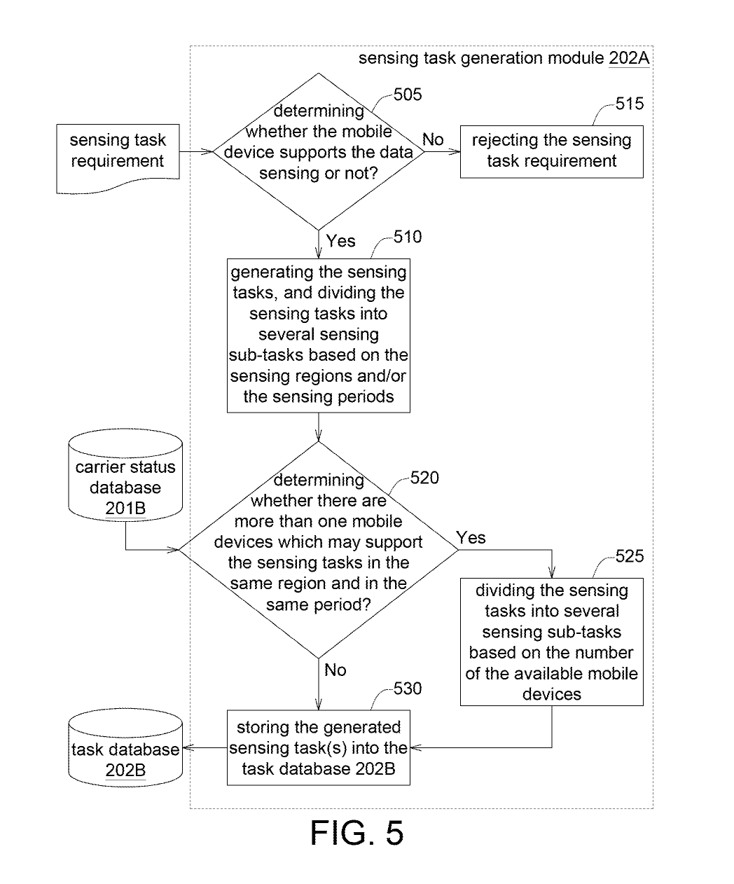

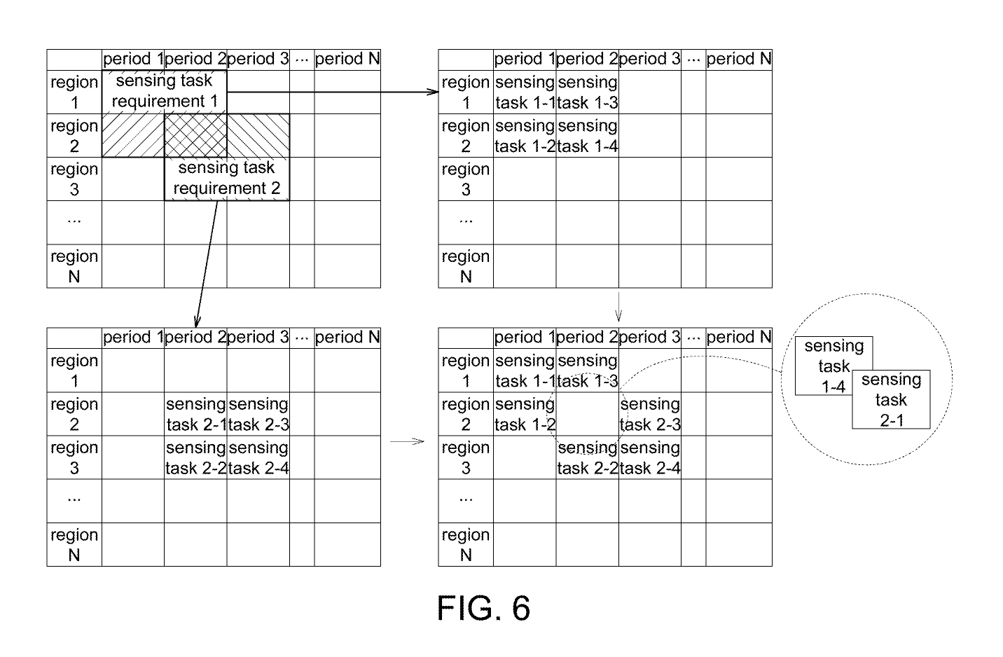

FIG. 4 shows a diagram for sensing task generation of the sensing task generation module 202A according to an embodiment of the application. FIG. 5 shows a flow chart for sensing task generation of the sensing task generation module 202A according to an embodiment of the application. FIG. 6 shows a diagram for sensing task partition of the sensing task generation module 202A according to an embodiment of the application.

As shown in FIG. 4, the sensing task generation module 202A reads the carrier status of the mobile device from the carrier status database 201B. The sensing task generation module 202A further receives sensing task requirement. The sensing task requirement includes at least one or any combination of the following: at least one sensing period (for example, a half hour is a period), at least one sensing region, at least one sensing item and at least one sensing criteria (for example but not limited by, at least one device moving speed, at least one sensing frequency and at least one number of sensing records). The sensing task generation module 202A generates one or more sensing tasks based on the sensing task requirement and the real-time carrier status information. The sensing task generation module 202A may further divide each of the sensing task(s) into one or more sensing sub-tasks based on the sensing regions and/or the sensing periods, as shown in FIG. 6. A sensing task includes a sensing task ID, sensing item(s) and sensing criteria. The sensing task(s) generated by the sensing task generation module 202A may store in the task database 202B. As shown in FIG. 4, the sensing task 1 is related to the period 1 and the region 1, and so on. Coverage of each region may be predefined and the details are not repeated here.

In FIG. 5, in step 505, based on the sensing task requirement, the sensing task generation module 202A determines whether the mobile device supports the data sensing or not (for example, when the sensing task requirement indicates to sense temperature, then the sensing task generation module 202A determines whether the mobile device supports temperature sensing). If no in step 505, then the sensing task generation module 202A rejects the sensing task requirement (step 515). If yes in step 505, then the sensing task generation module 202A generates the sensing tasks, and divides the sensing tasks into several sensing sub-tasks based on the sensing regions and/or the sensing periods (step 510). Further, based on the carrier status database 201B, the sensing task generation module 202A determines whether there are more than one mobile devices which may support the sensing tasks in the same region and in the same period (step 520). If yes in step 520, the sensing task generation module 202A divides the sensing tasks into several sensing sub-tasks based on the number of the mobile devices (step 525) and stores the generated sensing tasks into the task database 202B (step 530). If no in step 520, the sensing task generation module 202A generates new sensing task(s) and stores into the task database 202B (step 530).

As shown in FIG. 6, the sensing task requirement 1 is to be executed in the sensing region 1 to the sensing region 2 at the sensing period 1 to the sensing period 2; and the sensing task requirement 2 is to be executed in the sensing region 2 to the sensing region 3 at the sensing period 2 to the sensing period 3. Thus, based on the sensing task requirement 1, the sensing task generation module 202A generates the sensing tasks 1-1, 1-2, 1-3 and 1-4. Similarly, based on the sensing task requirement 2, the sensing task generation module 202A generates the sensing tasks 2-1, 2-2, 2-3 and 2-4. After combination, based on the sensing task requirement 1, the sensing task generation module 202A generates the sensing tasks 1-1, 1-2, 1-3, 1-4, 2-1, 2-2, 2-3 and 2-4 and stores in the task database 2026. Although the sensing tasks 1-4 and 2-1 are both executed in the sensing region 2 at the sensing period 2, the sensing tasks 1-4 and 2-1 doe not conflict. For example, two mobile devices may be assigned to execute the sensing tasks 1-4 and 2-1, respectively (as shown in the up-right and the left-down of FIG. 6). If there are several mobile devices available in the sensing regions at the sensing periods corresponding to the sensing tasks, then the sensing tasks may be divided based on the sensing items and/or the number of sensing records. For example, four sensing items are grouped into two groups of sensing item each group executed by a single mobile device. Or, a hundred sensing records are grouped into two sensing record groups, each group executed by a single mobile device.

That is, in an embodiment of the application, at least one of the sensing tasks may be divided into one or more sensing sub-tasks. Division into one or more sensing sub-tasks may include at least one or any combination of the following: dividing at least one sensing region into one or more sensing sub-regions; dividing at least one sensing period into one or more sensing sub-periods; dividing at least one sensing item into one or more sensing sub-items; and grouping one or more number of sensing records into one or more number of sensing records groups.

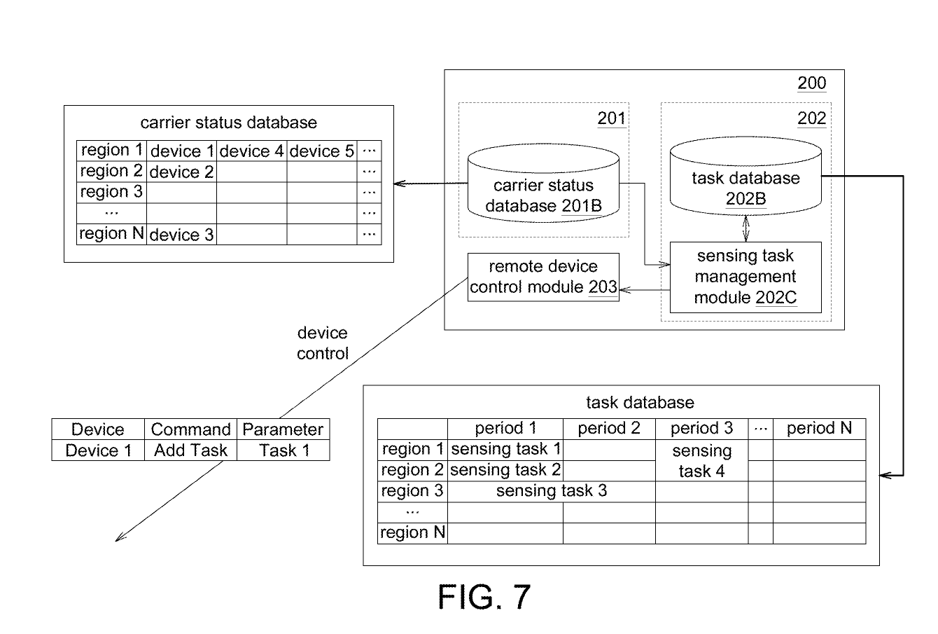

FIG. 7 shows a diagram for sensing task management according to an embodiment of the application. As shown in FIG. 7, the sensing task management module 202C assigns the mobile device to execute the sensing task based on the real-time carrier status. For example, the mobile device 1 is assigned to execute the sensing task 1 because the mobile device 1 is in the sensing region 1.

Based on the sensing tasks, the mobile device which meets the sensing criteria executes data sensing. For example, the sensing task management module 202C may pack the sensing task into the device control command(s) and send the device control command(s) to the remote device control module 203. The remote device control module 203 sends the device control command(s) to the mobile device 100. For example, a device control command may include three fields: the “device” field, the “command” field, and the “parameter” field. The “device” field indicates ID of the mobile device under control. The “command” field indicates the operations (for example “add task”) of the device control command. The “parameter” field indicates the content of this command. Thus, the device control command indicates “the mobile device 1 is assigned to execute the sensing task 1”.

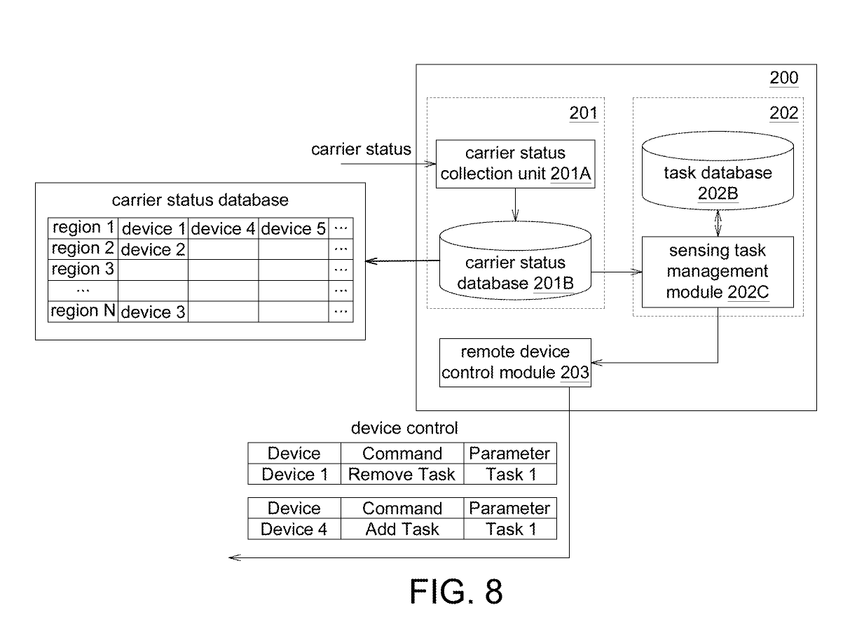

FIG. 8 shows a diagram for sensing task adjustment according to an embodiment of the application. As shown in FIG. 8, the sensing task management module 202C dynamically adjusts the sensing task assigned to the mobile device based on the real-time carrier status. For example, when a sensing task (executed in the sensing region 1) cannot be executed by the currently-assigned mobile device 1 (for example, the mobile device 1 moves from the sensing region 1 to the sensing region 2), the sensing task management module 202C assigns other mobile device(s) (for example the mobile device 4) to execute this the sensing task (because the mobile device 4 is in the sensing region 1). The remote device control module 230 sends the device control command to the mobile devices 1 and 4 (as shown in FIG. 8); and accordingly, the mobile device 1 is informed to stop the sensing task 1 and the mobile device 4 is informed to execute the sensing task 1.

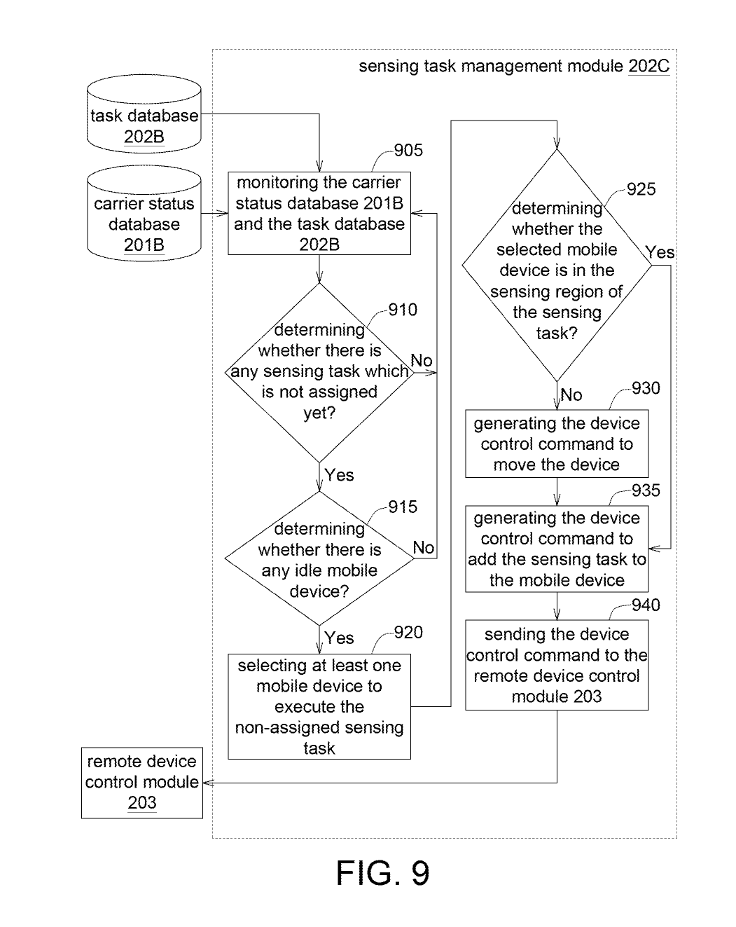

FIG. 9 shows a flow chart for sensing task adjustment according to an embodiment of the application. In step 905, the sensing task management module 202C monitors the carrier status database 201B and the task database 202B. In step 910, the sensing task management module 202C determines whether there is any sensing task which is not assigned yet. If no in step 910, then the flow returns to step 905. If yes in step 910, the sensing task management module 202C determines whether there is any idle mobile device (step 915). If no in step 915, then the flow returns to step 905. If yes in step 915, the sensing task management module 202C selects (or assigns) at least one mobile device to execute the non-assigned sensing task (step 920). In step 925, the sensing task management module 202C determines that whether the selected mobile device is in the sensing region of the sensing task. If no in step 925, then the sensing task management module 202C generates the device control command to move the device (step 930) and generates the device control command to add the sensing task to the mobile device (step 935). If yes in step 925, the flow proceeds to step 935. The sensing task management module 202C sends the device control command to the remote device control module 230 (step 940). In an embodiment of the application, if there is any idle mobile device (i.e. the idle mobile device is not assigned by any sensing task), the sensing task of other mobile device may be switched or assigned to the idle mobile device. Alternatively, the idle mobile device may be controlled to move to other sensing region to execute the sensing task(s) in the sensing region.

Step 920 may be executed by a multi-objective optimization algorithm, including for example but not limited by, mathematical programming based scalarization method or nature-inspired metaheuristic algorithm or other optimization algorithm.

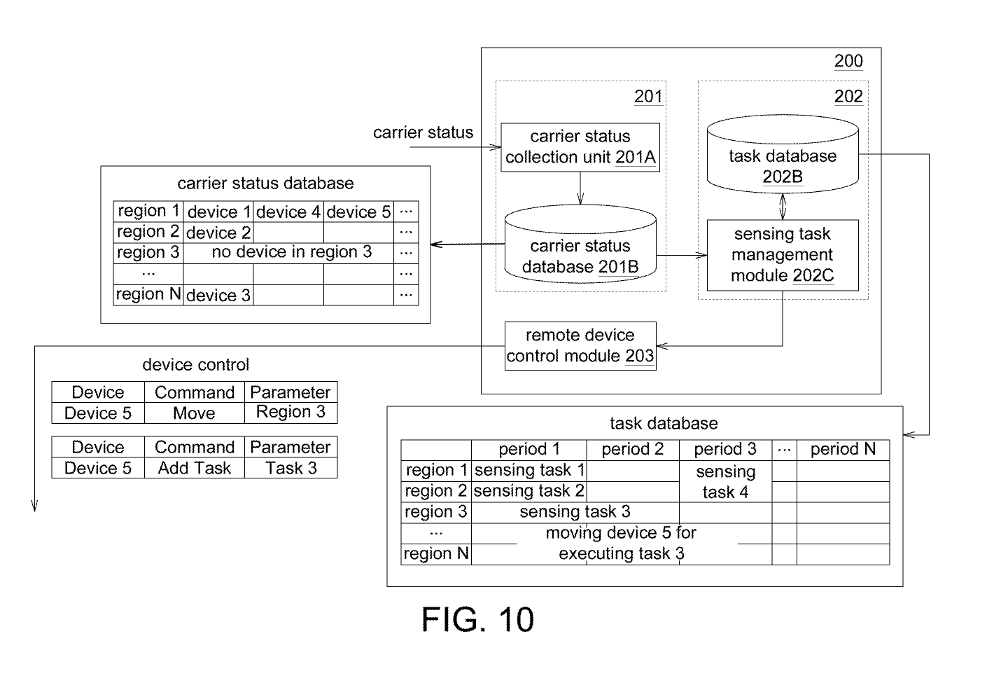

FIG. 10 shows a diagram for sensing task adjustment according to an embodiment of the application. As shown in FIG. 10, based on the real-time carrier status, when the sensing task management module 202C determines that there is no available mobile device in the sensing region of the sensing task, the sensing task management module 202C may control other available mobile device(s) to move into the sensing region to execute the sensing task.

For example, when there is no available mobile device in the sensing region 3, the sensing task management module 202C may control other available mobile device (for example the mobile device 5) to move into the sensing region 3 to execute the sensing task. In response to this, the mobile device 5 executes the sensing task 3.

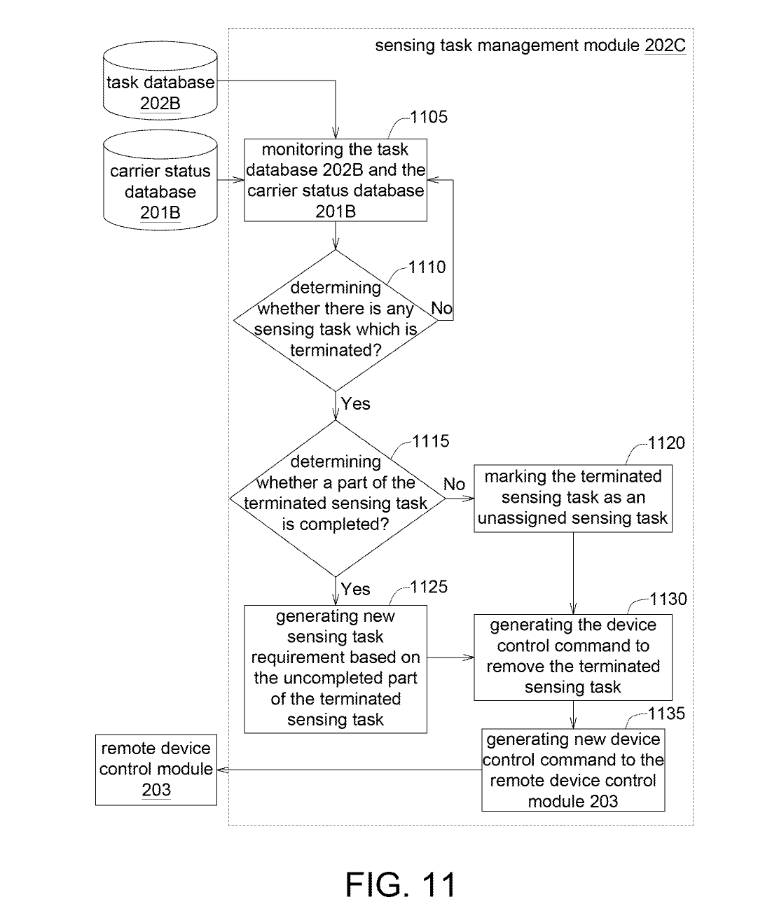

FIG. 11 shows a flow chart for sensing task adjustment according to an embodiment of the application. As shown in FIG. 11, in step 1105, the sensing task management module 202C monitors the task database 202B and the carrier status database 201B. In step 1110, the sensing task management module 202C determines whether there is any sensing task which is terminated. If no in step 1110, then the flow returns to step 1105. If yes in step 1110, the sensing task management module 202C determines whether a part of the terminated sensing task is completed (step 1115). If no in step 1115 (i.e. the completed progress of the terminated sensing task is 0), the sensing task management module 202C marks the terminated sensing task as an unassigned sensing task (step 1120). If yes in step 1115, the sensing task management module 202C generates new sensing task requirement based on the uncompleted part of the terminated sensing task (step 1125). After steps 1120 and 1125, the sensing task management module 202C generates the device control command to remove the terminated sensing task from the assigned mobile device (step 1130), and generates new device control command to the remote device control module 203 (step 1135).

In other words, in an embodiment of the application, when any sensing task is terminated, the terminated sensing task is marked as unassigned (if the complete progress of the terminated sensing task is 0%), or the uncompleted part of the terminated sensing task is packed into a new sensing task. For example, if the terminated sensing task is 60% completed, then the 40% uncompleted part of the terminated sensing task is packed into a new sensing task.

In an embodiment of the application, when the sensing task management module 202C of the sensing task generation and management module 202 determines that a sensing task of a mobile device is idled or when the sensing task management module 202C of the sensing task generation and management module 202 determines that any sensing task requirement is changed, the sensing task management module 202C of the sensing task generation and management module 202 dynamically adjusts the sensing task.

From the carrier status database 201B, at least one another mobile device which meets the sensing task requirement is selected to execute, dynamically adjusting the sensing task is performed.

How to select at least one another mobile device which meets the sensing task requirement may include at least one or any combination of the following: determining whether a current location of the mobile device meets the sensing task requirement, determining whether a sensor information of the mobile device meets the sensing task requirement (i.e. the sensor of the mobile device support the sensing item), and determining whether the mobile device is available to execute the sensing task.

Dynamically adjusting of the sensing task may include at least one or any combination of the following: guiding at least one another mobile device to move into the sensing region of the sensing task; and/or transferring the uncompleted sensing task to at least one another mobile device meeting the sensing task requirement.

Dynamically adjusting of the sensing task may include at least one or any combination of the following: stops at least one sensing task which is executed by the carrier, and/or generating at least one new sensing task.

In an embodiment of the application, when the mobile device completes a sensing task and the real-time communication quality is good, in response to request from the data sensing management system 200, the mobile device which completes the sensing task may return the sensing report to the data sensing management system 200. Further, in the sensing report database 204B of the sensing report collection module 204, the received sensing reports are stored by using the sensing period and the sensing region as index.

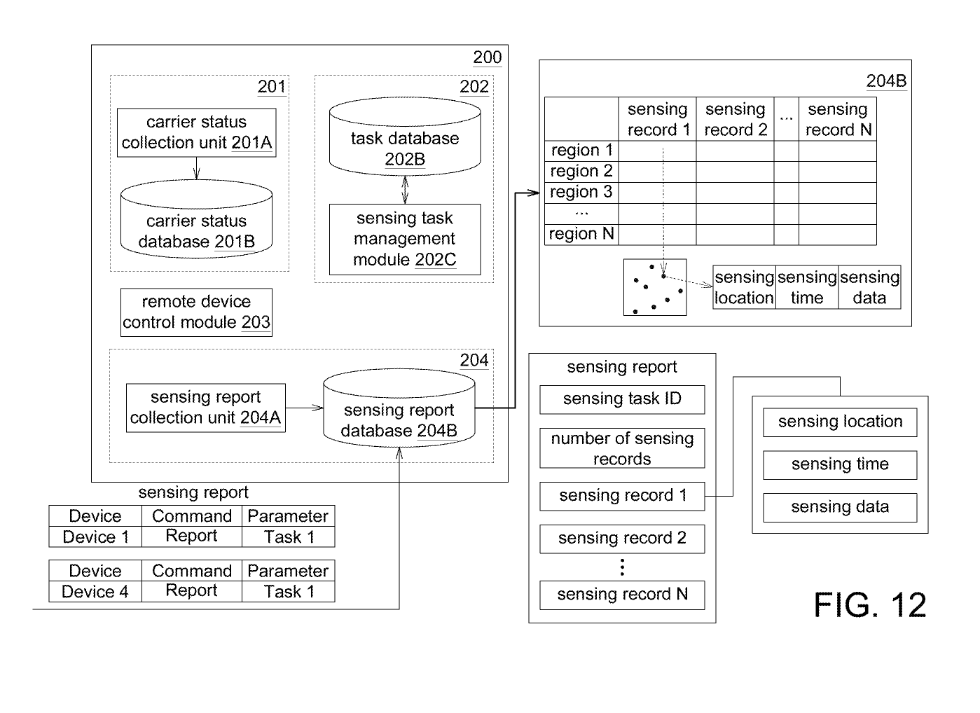

FIG. 12 shows a diagram for sensing report collection according to an embodiment of the application. In FIG. 12, in response to command from the data sensing management system 200, the mobile devices 1 and 4 (which both complete the sensing task 1) return the sensing reports to the sensing report collection module 204. A sensing report includes: the sensing task ID, the number of sensing records, and the content of each sensing record (including the sensing time, the sensing location and the sensing data). The sensing reports stored in the sensing report database 204B may be indexed by the sensing region.

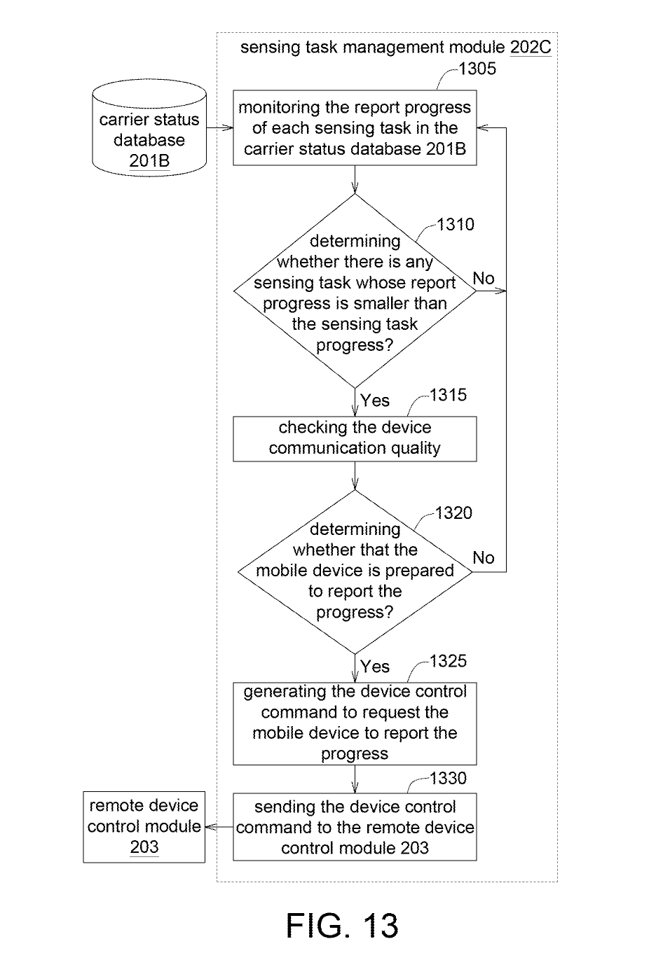

FIG. 13 shows a flow chart for sensing report collection according to an embodiment of the application. In step 1305, the sensing task management module 202C monitors the report progress of each sensing task in the carrier status database 201B. In step 1310, the sensing task management module 202C determines whether there is any sensing task whose report progress is smaller than the sensing task progress (the sensing task progress indicating the progress which is completed by the mobile device, while the report progress indicates the progress that the mobile device reports sensing data). If no in step 1310, then the flow returns to step 1305. If yes in step 1310 (which may be caused by bad communication quality), the sensing task management module 202C checks the device communication quality (step 1315). If the device communication quality is good, the sensing task management module 202C determines that the mobile device is prepared to report the progress (step 1320). After step 1320, the sensing task management module 202C generates the device control command to request the mobile device to report the progress (step 1325) and sends the device control command to the remote device control module 203 (step 1330).

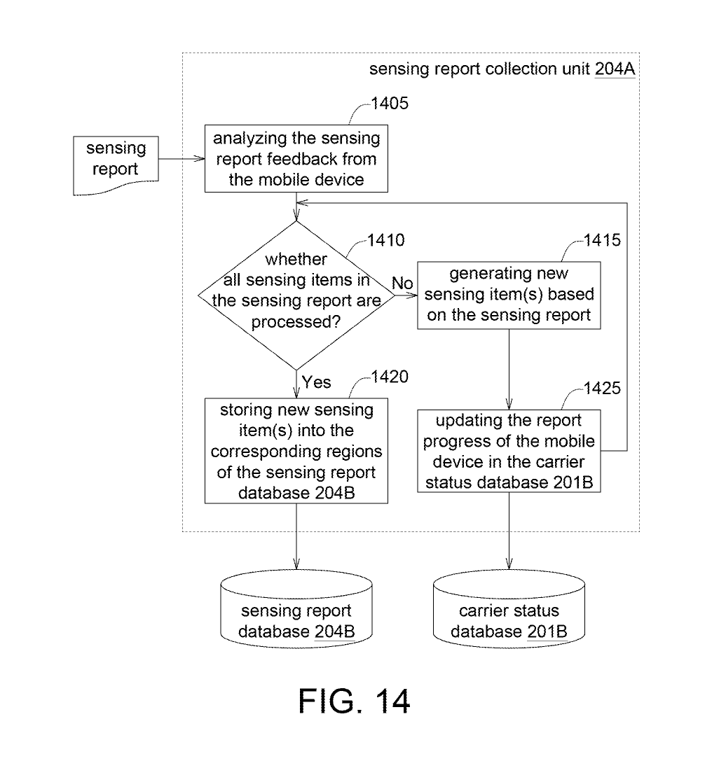

FIG. 14 shows a flow chart for sensing report analysis according to an embodiment of the application. In step 1405, the sensing report collection unit 204A analyzes the sensing report feedback from the mobile device. In step 1410, the sensing report collection unit 204A determines whether all sensing items in the sensing report (in FIG. 12) are processed. If no in step 1410, the sensing report collection unit 204A generates new sensing item(s) based on the sensing report (step 1415) and updates the report progress of the mobile device in the carrier status database 201B (step 1425). If yes in step 1410, the sensing report collection unit 204A stores new sensing item(s) into the corresponding regions of the sensing report database 204B (step 1420).

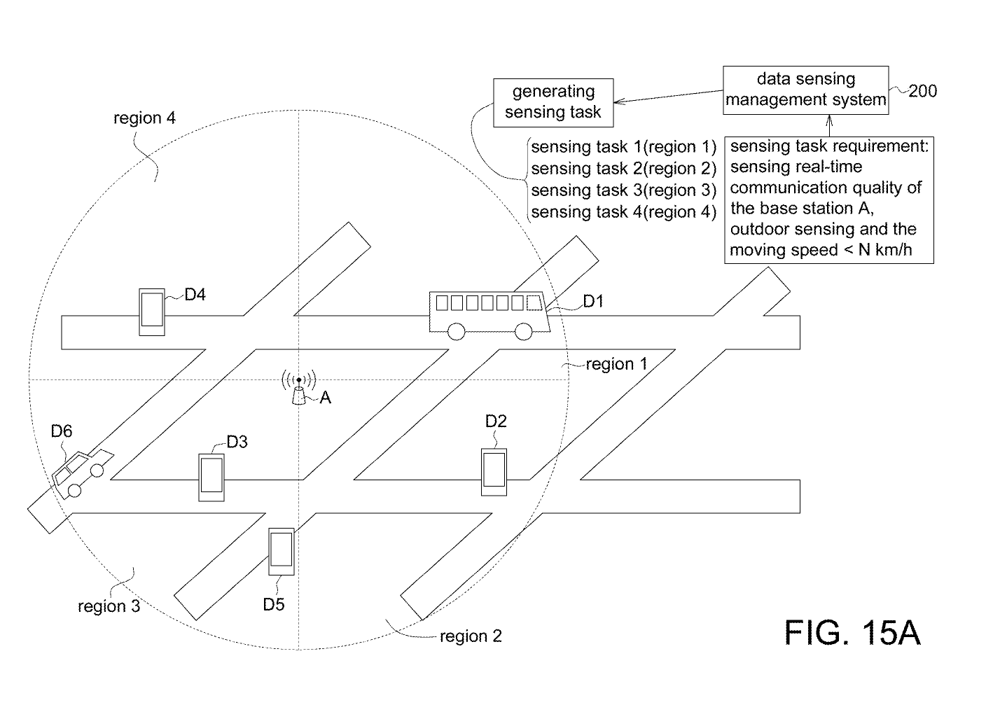

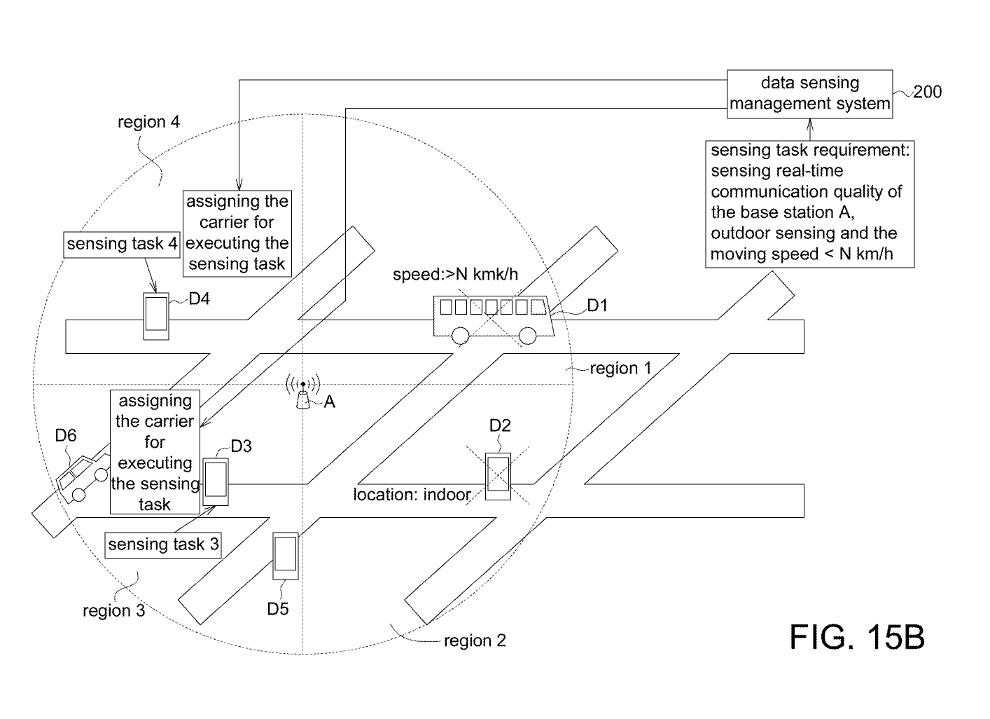

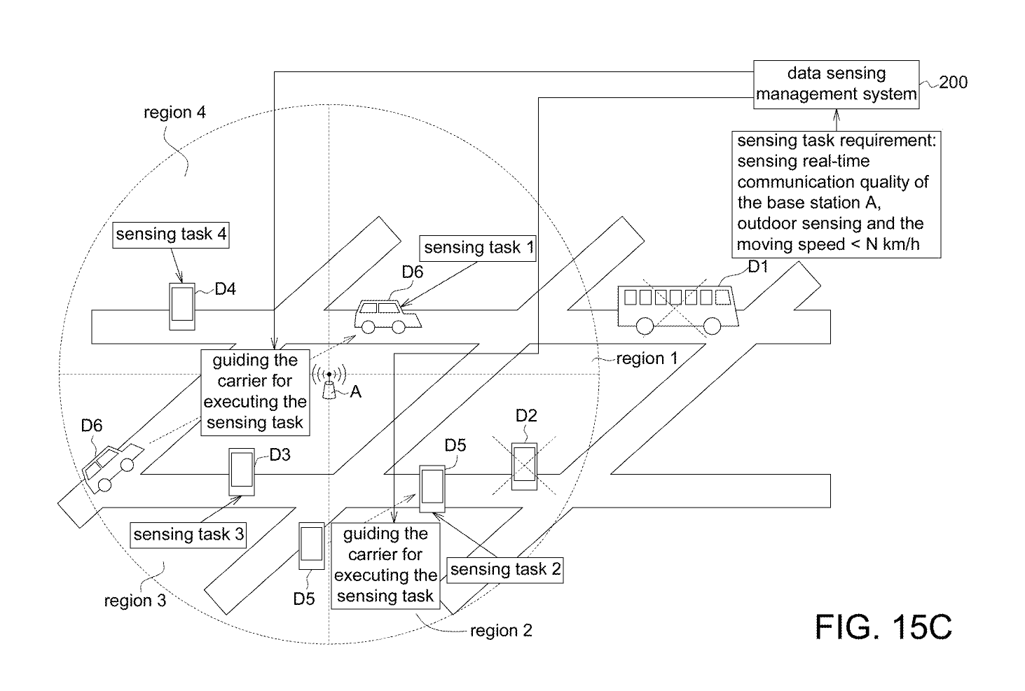

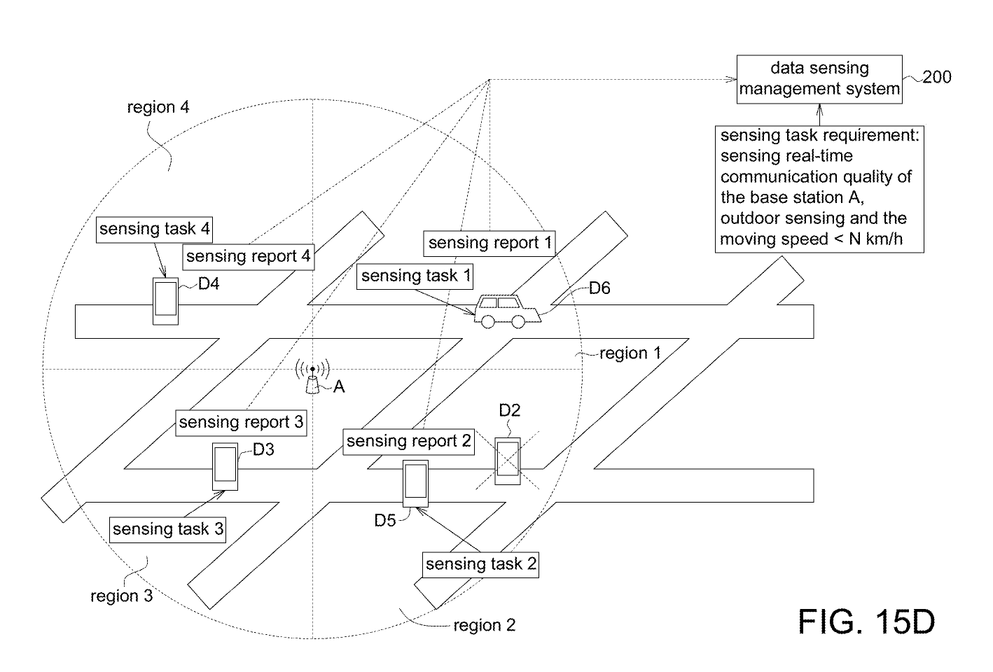

FIGS. 15A-15D shows an example of communication quality monitoring according to an embodiment of the application. In FIG. 15A, the data sensing management system 200 receives the sensing requirement which includes (1) sensing the real-time communication quality of the base station A; (2) outdoor sensing and (3) the moving speed of the mobile device (the carrier) executing sensing should be smaller than N km/h. Based on this sensing requirement, the data sensing management system 200 generates the sensing task 1 (executed in the sensing region 1), the sensing task 2 (executed in the sensing region 2), the sensing task 3 (executed in the sensing region 3) and the sensing task 4 (executed in the sensing region 4). For simplicity, FIG. 15A-15D show six carriers D1-D6. The embodiment of the application in FIG. 15A-15D is based on crowdsourcing.

In FIG. 15B, the data sensing management system 200 assigns the sensing tasks. The carriers D1 and D2 are not assigned because the carrier D1 has higher moving speed than the sensing requirement and the carrier D2 is indoor. After analysis, the data sensing management system 200 assigns the sensing tasks 3 and 4 to the carriers D3 and D4, respectively. That is, the sensing tasks 1 and 2 are not assigned yet.

In FIG. 15C, the data sensing management system 200 guides the carriers D3 and D6 to move for executing sensing tasks. That is, the data sensing management system 200 guides the carriers D6 to move from the region 3 to the region 1 for executing the sensing task 1; and the data sensing management system 200 guides the carriers D3 to move from the region 3 to the region 2 for executing the sensing task 2.

In FIG. 15D, the data sensing management system 200 requests the carriers to return the sensing report. Thus, the carriers D6, D5, D3 and D4 return the sensing reports 1-4 to the data sensing management system 200.

In an embodiment of the application, based on the carrier status information of the carrier (or the mobile device), the sensing report collection module 204 estimates whether a returning frequency of at least one sensing data from the mobile device meets the sensing task requirement. If the returning frequency of the at least one sensing data from the mobile device does not meet the sensing task requirement, dynamically adjusting at least one sensing data returning method is performed. Dynamically adjusting the sensing data returning method by the sensing report collection module 204 includes at least one or any combination of the following: negotiating with at least one nearby carrier to stagger the data return time point and/or compressing the sensing data.

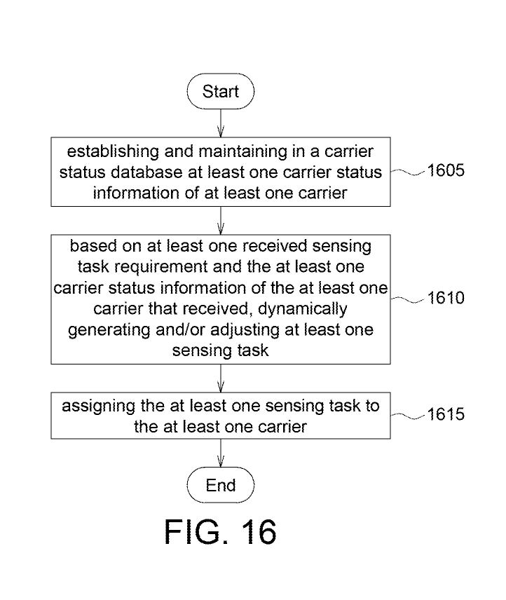

FIG. 16 shows a flow chart for a data sensing method according to an embodiment of the application. The data sensing method includes: establishing and maintaining in a carrier status database at least one carrier status information of at least one carrier (step 1605); based on at least one received sensing task requirement and the at least one carrier status information of the at least one carrier that received, dynamically generating and/or adjusting at least one sensing task (step 1610); and assigning the at least one sensing task to the at least one carrier (step 1615).

An embodiment of the application provides a computer-readable storage media which stores one or more programs. The one or more programs include a plurality of commands. When the one or more programs are read by one or more processors of a data sensing management system, the data sensing management system executes the above data sensing method.

In the data sensing method, the data sensing management system and the computer-readable storage media of the embodiments of the application, real-time mobile sensing is one of the targets. Automatic data sensing and aggregation are performed by the carrier (or the mobile device) and the data sensing management system. Thus, huge data storage and analysis efficiency are improved.

The embodiments of the application provide real-time mobile data sensing and aggregation system and method based on crowdsourcing. In the embodiments of the application, via monitoring the carrier status of the carrier or the mobile device, the real-time carrier information is established. In the embodiments of the application, based on the real-time carrier information and the data sensing requirement, sensing tasks are programmed. In the embodiments of the application, based on the real-time carrier information, assignment of the sensing tasks is dynamically adjusted.

The embodiments of the application may have advantages of high sensing quality, high sensing adaption, high sensing accuracy and real-time data sensing. Thus, the embodiments of the application may meet the requirement of real-time mobile data sensing.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A data sensing method, comprising:
dynamically establishing and dynamically maintaining in a carrier status database at least one carrier status information of at least one carrier that received;
based on at least one sensing task requirement and the at least one carrier status information of the at least one carrier that received, dynamically generating and/or adjusting at least one sensing task; and
assigning the at least one sensing task to the at least one carrier.

2. The data sensing method according to claim 1, wherein the at least one carrier status information of the at least one carrier includes at least one of the following: at least one carrier information and at least one sensing task information.

3. The data sensing method according to claim 2, wherein the at least one carrier information includes at least one or any combination of the following: a carrier identification, a location, a moving speed, a moving direction, a communication status and a sensor information.

4. The data sensing method according to claim 2, wherein the at least one sensing task information includes at least one or any combination of the following: a sensing task ID, a sensing task progress and a report progress.

5. The data sensing method according to claim 1, further including:
dividing each of the at least one sensing task into one or more sensing sub-tasks;
wherein dividing each of the at least one sensing task into the one or more sensing sub-tasks, includes at least one or any combination of the following: dividing at least one sensing region into one or more sensing sub-regions; dividing at least one sensing period into one or more sensing sub-periods; dividing at least one sensing item into one or more sensing sub-items; and grouping one or more number of sensing records into one or more number of sensing records groups.

6. The data sensing method according to claim 1, wherein the at least one sensing task requirement includes at least one or any combination of the following: at least one sensing period, at least one sensing region, at least one sensing item, at least one sensing frequency and at least one number of sensing record.

7. The data sensing method according to claim 1, wherein when the at least one sensing task of the at least one carrier is idled, or when the at least one sensing task requirement is changed, the at least one sensing task is dynamically adjusted.

8. The data sensing method according to claim 7, wherein from the carrier status database, at least one another carrier meeting the at least one sensing task requirement is selected to execute the adjusted at least one sensing task.

9. The data sensing method according to claim 8, wherein the selected at least one another carrier meeting the at least one sensing task requirement includes at least one or any combination of the following: determining whether a current location of the at least one another carrier matches, determining whether a sensor information of the at least one another carrier matches, and determining whether the at least one another carrier is available for executing the at least one sensing task.

10. The data sensing method according to claim 8, wherein the dynamically adjusting of the at least one sensing task includes at least one or any combination of the following: guiding at least one another carrier not meeting the at least one sensing task requirement to a sensing region meeting the at least one sensing task requirement, and/or transferring a uncompleted part of the at least one sensing task to at least one another carrier meeting the at least one sensing task requirement.

11. The data sensing method according to claim 7, wherein the dynamically adjusting of the at least one sensing task includes at least one or any combination of the following: stopping the at least one carrier from executing the at least one sensing task, and generating at least one new sensing task.

12. The data sensing method according to claim 1, further including:
based on the at least one carrier status information of the at least one carrier, estimating whether a returning frequency of at last one sensing data from the at least one carrier meets the at least one sensing task requirement; and
if the returning frequency of the at least one sensing data fails to meet the at least one sensing task requirement, dynamically adjusting at least one sensing data returning method.

13. The data sensing method according to claim 12, wherein the dynamically adjusting of the at least one sensing data returning method includes at least one or any combination of the following: negotiating with at least one nearby carrier to stagger a sensing data return time point and compressing sensing data.

14. A data sensing management system communicating with at least one carrier via at least one network, the data sensing management system comprising:
a carrier status database;
a carrier status collection module, being configured for dynamically establishing and dynamically maintaining, in the carrier status database, at least one carrier status information of the at least one carrier that received; and
a sensing task generation and management module, being configured for dynamically generating and/or adjusting at least one sensing task based on at least one sensing task requirement and the at least one carrier status information of the at least one carrier that received, and for assigning the at least one sensing task to the at least one carrier.

15. The data sensing management system according to claim 14, wherein the at least one carrier status information of the at least one carrier includes at least one of the following: at least one carrier information and at least one sensing task information.

16. The data sensing management system according to claim 15, wherein the at least one carrier information includes at least one or any combination of the following: a carrier identification, a location, a moving speed, a moving direction, a communication status and a sensor information.

17. The data sensing management system according to claim 15, wherein the at least one sensing task information includes at least one or any combination of the following: a sensing task ID, a sensing task progress and a report progress.

18. The data sensing management system according to claim 14, wherein:
the sensing task generation and management module divides each of the at least one sensing task into one or more sensing sub-tasks,
wherein when the sensing task generation and management module divides each of the at least one sensing task into the one or more sensing sub-tasks, the sensing task generation and management module divides at least one sensing region into one or more sensing sub-regions, and/or divides at least one sensing period into one or more sensing sub-periods, and/or divides at least one sensing item into one or more sensing sub-items, and/or groups one or more number of sensing records into one or more number of sensing records groups.

19. The data sensing management system according to claim 14, wherein the at least one sensing task requirement includes at least one or any combination of the following: at least one sensing period, at least one sensing region, at least one sensing item, at least one sensing frequency and at least one number of sensing record.

20. The data sensing management system according to claim 14, wherein when the sensing task generation and management module determines that the at least one sensing task of the at least one carrier is idled, or when the sensing task generation and management module determines that the at least one sensing task requirement is changed, the sensing task generation and management module dynamically adjusts the at least one sensing task.

21. The data sensing management system according to claim 20, wherein from the carrier status database, the sensing task generation and management module selects at least one another carrier meeting the adjusted at least one sensing task requirement to execute the at least one sensing task.

22. The data sensing management system according to claim 21, wherein the sensing task generation and management module selects the at least one another carrier meeting the at least one sensing task requirement, the sensing task generation and management module determines at least one or any combination of the following: determining whether a current location of the at least one another carrier matches, determining whether a sensor information of the at least one another carrier matches, and determining whether the at least one another carrier is available for executing the at least one sensing task.

23. The data sensing management system according to claim 22, wherein the sensing task generation and management module dynamic adjusts the at least one sensing task, the sensing task generation and management module performs at least one or any combination of the following: guiding at least one another carrier not meeting the at least one sensing task requirement to a sensing region meeting the at least one sensing task requirement, and/or transferring a uncompleted part of the at least one sensing task to at least one another carrier meeting the at least one sensing task requirement.

24. The data sensing management system according to claim 20, wherein the sensing task generation and management module dynamic adjusts the at least one sensing task, the sensing task generation and management module performs at least one or any combination of the following: stopping the at least one carrier from executing the at least one sensing task, and generating at least one new sensing task.

25. The data sensing management system according to claim 14, further including a sensing report collection module,
wherein
based on the at least one carrier status information of the at least one carrier, the sensing report collection module estimates whether a returning frequency of at least one sensing data from the at least one carrier meets the at least one sensing task requirement; and
if the returning frequency of the at least one sensing data fails to meet the at least one sensing task requirement, the sensing report collection module dynamically adjusts at least one sensing data returning method.

26. The data sensing management system according to claim 25, wherein the sensing report collection module dynamic adjusts the sensing data returning method by executing at least one or any combination of the following: negotiating with at least one nearby carrier to stagger a sensing data return time point and/or compressing sensing data.

27. A computer-readable storage media storing one or more programs, the one or more programs including a plurality of commands, wherein when the one or more programs is read by one or more processors of a data sensing management system, the data sensing management system executes the data sensing method in claim 1.
